(19) United States
(12) Patent Application Publication
(10) Pub. No.: US 2025/0207449 A1
(43) Pub. Date: Jun. 26, 2025

(54) VEHICLE ARRANGEMENT COMPRISING A SLIDING DOOR AND A RESTRAINT DEVICE

(71) Applicant: RENAULT SAS, BOULOGNE BILLANCOURT (FR)

(72) Inventor: Olivier ROLAND, VILLIERS SAINT-FREDERIC (FR)

(21) Appl. No.: 18/991,104

(22) Filed: Dec. 20, 2024

(30) Foreign Application Priority Data
Dec. 21, 2023 (FR) 2314838

(51) Int. Cl. E05F 5/00

(52) U.S. Cl. CPC E05F 5/003; E05Y 2900/531

(57) ABSTRACT

An arrangement (2) of a motor vehicle including a body (6) and a partition sliding door (4), the sliding door (4) being configured to be rectilinearly moved along a side (3) of the body between opening and closing positions. The sliding door (4) comprises a longitudinal rectilinear opening (40) provided in the sliding door, and in that the arrangement comprises at least a restraint device (10) intended to hold the sliding door (4) in the closed position thereof, the restraint device (10) being intended to move freely inside the longitudinal rectilinear opening (40) during the sliding of the door.

The invention relates to an arrangement of a vehicle comprising a partition sliding door and a restraint device. The invention further relates to automotive vehicle comprising such an arrangement.

Some motor vehicles are equipped with sliding rear doors that close or free the access to the passenger compartment and/or a loading area of the motor vehicle same equip. For each sliding door, a restraint device, commonly referred to as an “impact restraint pin”, is generally fastened to the body of the motor vehicle, e.g. at the pillar B, in order to retain, if need be, the front part of the sliding rear door. Such an “impact restraint pin” is described e.g. in patent application DE 10 2007 051 718 A1.

A restraint device is used to hold the sliding rear door in the closed position thereof, thereby preventing the sliding rear door from opening in the event of relative transverse movement of the sliding rear door relative to the body, inward and/or outward. A restraint device known from the state of the art is generally similar to a male part supported by the body of the motor vehicle, the male part then being configured to be inserted into a female housing such as a hole made in the casing of the sliding rear side door, at the front part of the rear door.

Thereby, in the case of a forced transverse displacement of the sliding rear door outwards during an impact, the restraint device comes into abutment against the wall delimiting a housing arranged in the sliding side rear door casing so as to mechanically connect the latter to the body of the vehicle, thereby preventing the door from opening outwards.

Thereby, according to the solutions known in the prior art, the rear sliding door is held in the closed position thereof by a restraint pin the positioning of which on the body is strongly conditioned to the normal kinematics of displacement of the door, in particular at the end of the closing travel. Very often such kinematics of displacement of the door are complex, in the sense that the kinematics simultaneously combines concomitant movements of movement of the front of the sliding rear door along longitudinal and transverse axes. The positioning of the restraint pin to be integrated into the body is all the more complex to achieve when the kinematics of the door displacement is oriented in an inclined manner from the front and the inside of the vehicle.

The goal of the invention is to propose an alternative to the known solutions and to propose a simpler solution for a service front door for a utility vehicle.

To this end, the invention relates to an arrangement of a motor vehicle, in particular of one side of the vehicle, including a body and a partition sliding door, in particular with external partition, the sliding door being configured to be moved rectilinearly along body side, between a closed position wherein the sliding door closes an access to the inside of a passenger compartment and/or a zone of loading of the vehicle, between an open position wherein the sliding door gives free access to the inside of said passenger compartment and/or said zone of loading of the vehicle, the arrangement being characterized in that the sliding door comprises a longitudinal rectilinear opening, in particular like a kerf or a groove, provided in the sliding door, in particular at a casing bottom wall of the sliding door, and in that the arrangement comprises at least a restraint device intended to hold said sliding door in the closed position thereof, in particular in the event of an impact exerted laterally against the sliding door, in particular from the inside to the outside of the vehicle, the restraint device being intended to move freely inside the longitudinal rectilinear opening during the sliding of the door.

According to the invention, the arrangement may comprise the following features, taken separately or in combination with each other:
the restraint device is fastened to a front pillar of a body side, in particular at a rear edge of a front pillar intended to be arranged opposite a front edge of the sliding door in the closed position;
the restraint device is fastened to a middle pillar of a body side, in particular at a front edge of the middle pillar extending substantially perpendicular, in particular transverse, to the inner wall of the sliding door;
the sliding door, in particular the outer wall of the front door, in closed position is flush with a front pillar, in particular of an outer wall of the front pillar;
the restraint device comprising a finger protruding outside the body side of the vehicle, in particular outside the rear edge of the front pillar, said finger including a main rod extending longitudinally to the vehicle, a free end of which comprises a head, in particular in the shape of a hook or a disk, the restraint device being spaced apart from the door, in particular from the front edge of the sliding door, so that same can move freely between the open and closed positions without coming into contact with the restraint device;
the casing bottom wall of the sliding door extends opposite an outer edge of the middle pillar whatever the position of the sliding door;
the restraint device comprises a finger protruding transversally outside the body side of the vehicle, said finger including a main rod extending longitudinally to the vehicle, a free end of which comprises a head, in particular in the shape of a hook or a disk;
said finger includes a plate for fastening to the body side, in particular a fastening plate screwed onto the rear face of the front pillar or onto the front face of the middle pillar;
the restraint device is intended to come into contact with the sliding door so as to hold same in the closed position on the body side during a lateral impact,
the restraint device is spaced apart from the sliding door, in particular spaced apart from the edges of the longitudinal opening and/or of a passage provided at the transverse wall, the restraint device being intended to come into mechanical relation against the door in the closed position during an impact, in particular against the transverse edge of the casing, the wall being in particular a reinforcement part directly mounted on the casing bottom wall;
the arrangement comprises a deformable element for masking said longitudinal housing, in particular an element such as a lip seal, letting through the restraint device so as in particular to move apart the lips.

The invention further relates to a motor vehicle comprising an arrangement having all or part of the above-mentioned characteristics.

The subject matters, features and advantages of the present invention will be described in detail in the following description of specific embodiments given by way of illustration and not limiting with reference to the accompanying drawings, wherein:

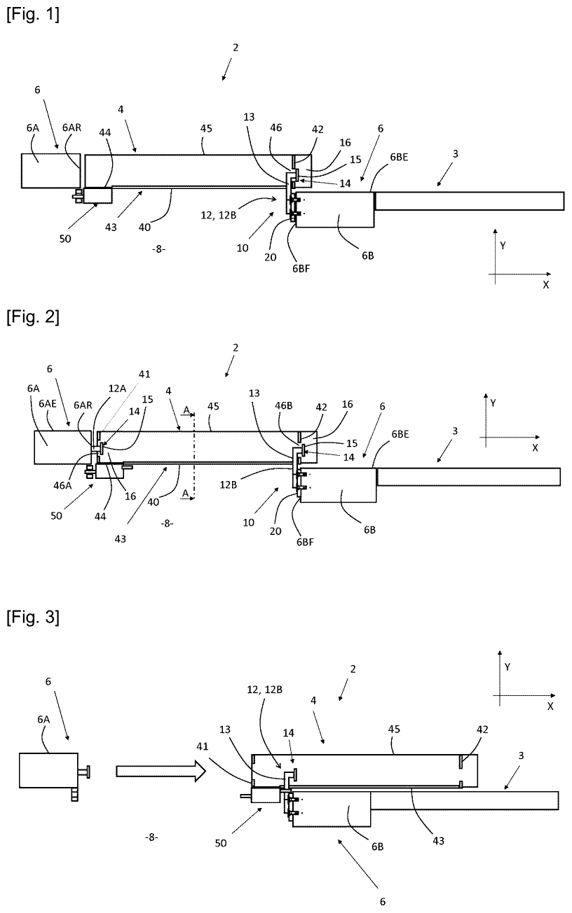

FIG. 1 schematically illustrates a vertical axis section of an arrangement of a motor vehicle body including a partition sliding door and a restraint device, the door being in the closed position, according to the invention.

FIG. 2 schematically illustrates a variant of embodiment of an arrangement of FIG. 1, the door being in the closed position, according to the invention.

FIG. 3 shows the arrangement of FIG. 2 with the sliding door in the open position, according to the invention.

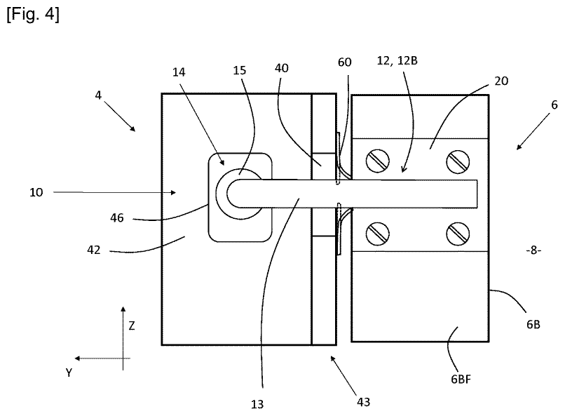

FIG. 4 is a section view of an axis A-A of FIG. 1 according to the invention.

A trihedron with three axes X, Y, Z is illustrated in certain figures. In the present document, the axis X refers to the longitudinal axis of the motor vehicle. In forward travel and in a straight line, the vehicle moves from rear to front, along a direction parallel to the longitudinal axis thereof. The axis X is oriented from the front to the rear of the vehicle, i.e. in the direction of reversing. The axis Y is the transverse axis of the vehicle. The axis Z is the axis perpendicular to the axis X and to the axis Y. The vehicle is considered to be on a horizontal ground. The axis Z is a vertical axis, oriented from bottom to top. The axes X, Y and Z form an orthogonal coordinate system.

There are a plurality of types of body arrangement 2 including a sliding door for a motor vehicle. In general, the so-called “conventional” sliding doors are distinguished from the so-called “partition” sliding doors 4.

A sliding door of a motor vehicle is said to be “conventional” when the displacement of the sliding door from the closed position thereof to the open position thereof or vice versa involves a lateral displacement of the door toward the outside of the vehicle. In other words, in a “conventional” sliding door arrangement, the movement of said sliding door is not a rectilinear translation along a single axis of displacement, in particular along a longitudinal axis for a sliding side door, but a displacement in two mutually perpendicular directions, in particular along the lateral direction Y and along the longitudinal direction X.

A sliding door 4 of a motor vehicle called “partition door” when the sliding door 4 is not displaced laterally outwards during the movements thereof between the open and closed positions thereof. In other words, in an arrangement 2 of a vehicle body including a partition sliding door 4 for a motor vehicle, the sliding door 4 is movable in rectilinear translation between the open and closed positions thereof along a single direction, parallel to the axis X of the motor vehicle.

There are also two sub-categories of body arrangements 2 including partition sliding door 4, namely the inner partition sliding door 4 and the outer partition sliding door 4.

In the case of inner partition sliding doors 4, the sliding door 4 slides along the inner side of a body 6 of the motor vehicle. Thereby, when the sliding door 4 is in the open position thereof, said sliding door 4 is located behind a pillar of the motor vehicle, inside the passenger compartment 8 or of a loading zone of said motor vehicle.

In the case of outer partition sliding doors 4, the sliding door 4 slides along the outer side 3 of the body 6 of the motor vehicle, i.e. in front of the pillar of the body seen from the outside, so that the door is continuously visible. Thereby, said sliding door 4 is situated on the outer side 3 and outside the passenger compartment 8 of said motor vehicle both in the open position thereof and in the closed position thereof, as can be seen in FIG. 1, FIG. 2 and FIG. 3.

In such an arrangement 2, it is possible to design a restraint device 10 for keeping the outer partition sliding door 4 in the closed position thereof, in particular in the case of an impact exerted laterally against the sliding door 4. Such an impact exerts a force against the sliding door oriented either inwards or outwards on the door, such that the restraint device is apt to prevent the intrusion of the door into the passenger compartment or loading zone or to hold the opening of the body in the closed state by means of the door.

FIG. 1, FIG. 2 and FIG. 3 schematically illustrate sectional views of an arrangement 2 of a lateral side 3 of a motor vehicle comprising a sliding door 4 with external partition and a restraint device 12, 12A and 12B. In FIG. 1, the sliding door 4 is shown in the closed position thereof. Same is a service door which, in the closed position, extends transversely to the right of the driver's seat or of the row of seats among which the driver's seat is located. In the closed position, the sliding door 4 closes the access to the inside of a passenger compartment 8 and/or to a loading compartment of the motor vehicle. The opening of the body 6 which is intended to be closed by the sliding door 4 is delimited in part by the front pillar 6A and the middle pillar 6B. In the closed position, the front edge of the door 4 is arranged in the continuation of the front pillar 6A, in the sense that the rear wall 6AR of the front pillar 6A is arranged opposite the front edge of the door 4, whereas the rear edge of the door 4 is arranged overlapping the outside of the middle pillar 6B, the inside wall of the door 5 being partially arranged overlapping the outside wall 6BE of the middle pillar 6B. The middle pillar 6B is transversely offset inwards with respect to the front pillar 6A, so that the offset along Y is substantially related to the thickness of the sliding door 4.

Thereby, the restraint device 10 comprises a protuberant rod 12 supported by one side 3 of the body 6 of the motor vehicle. More precisely, the protuberant rod 12 protrudes from a middle pillar of said vehicle body 6, commonly called pillar BO. The protuberant rod 12 comprises a free end 14 which has a disk shape. According to a variant of embodiment (not shown), thereof could be a free end 14 having a hook shape. The free end 14 is configured to hold the sliding door 4 in the closed position thereof, in particular in the case of an impact exerted laterally against said sliding door 4.

In the specific embodiment illustrated in FIG. 1, the free end 14 cooperates with a housing 16 arranged in the sliding door 4 so as to maintain said door 4 in the closed position thereof. The housing 16 may be delimited by a casing 43 of the door 4, said box comprising a bottom wall, the inner face of which is intended to come opposite the middle pillar 6A, as illustrated in FIG. 3. The housing 16 may be delimited by at least one transverse partition wall 42, which extends vertically in the door 4. The portion of the protuberant rod 12 which extends along the axis X passes through the transverse partition wall 42 via a dedicated opening 46 which at a minimum has a section substantially mating with the free end 14, within the sliding play. FIG. 4 represents a particular embodiment which will be described in detail thereafter.

The casing 43 of the door 4 includes a longitudinal opening 40 which extends from the rear housing 16 towards the front part of the door 4. The dimension of the opening 40 is rectilinear and has the axis X and is greater than the opening travel of the door so that the restraint device 10 extending through the opening 40 along a direction having the axis Y can move freely when the door 4 is moved between the open and closed positions thereof. The height of the opening 40 is greater than that of the protuberant rod 12 so that the free end 14 can move through the rectilinear opening 40 when the restraint device 10 is mounted on the side 3 of the body 6.

The rectilinear opening 40 may be a kerf or a groove formed in the bottom wall of the casing 43.

According to a specific embodiment of the restraint device 10, thereof is a single one-piece part, which makes same more robust. In such embodiment, the protuberant rod 12 has a substantially square cross-section. More generally, the protuberant rod 12 may have a cross-section with a polygonal shape. At the junction between the protuberant rod 12 and the free end 14 thereof, a connecting block in the form of a prism with a triangular base may be present in order to reinforce the junction between the protuberant rod 12 and the free end 14 thereof.

According to a specific embodiment of the restraint device 10, a fastening plate 20 is rigidly attached to the protuberant rod 12, in particular by welding. In FIG. 4, such a fastening plate 20 is shown with screwing means for an assembly on the middle pillar 6B, more particularly on the front wall 6BF.

According to a particular architecture of the arrangement 2, the front wall 6BF of the middle pillar 6B extends transversely to the extension of the transverse partition 42 of the door 4 in the closed position. Such a design particularity aims to distribute the force of an external impact applied to the door 4 directly over a highly structuring zone of the middle pillar 6B.

The front part of the door 4 may comprise a locking system 50 providing the locking of the door on the front pillar 6A.

According to the variant of embodiment of FIG. 2, the restraint device 10 comprises another protuberant finger 12A supported by the front pillar 6A. In the present case, said other protuberant finger 12A is arranged protruding out of the rear wall 6AR of the front pillar 6A. Same may be arranged vertically at the same level as the protruding finger 12B of the middle pillar 6B. The sliding door 4 comprises a front end edge wherein an opening 46A is provided, through which said other protuberant finger 12A is apt to extend when the door is in the closed position. The opening 46A provided at the front edge of the door 4 can then be substantially coaxial with the opening 46B provided at the transverse partition wall 42. Such an architecture with double restraint fingers serves to distribute the lateral forces of an impact applied to the door between the front pillar 6A and the middle pillar 6B. The dimensioning of each of the protuberant rods 12A, 12B can be reduced, compared with the embodiment shown in FIG. 1, the restraint device 10 of which comprises a single protuberant finger 12 at the middle pillar 6B.

In FIG. 3, the sliding door 4 of FIG. 2 is shown in the open position thereof. In the open position, the sliding door 4 frees access to the inside of the vehicle. An arrow indicates the direction of travel of the sliding door 4 when it is moved from its closed position to the open position thereof.

In all possible embodiments of the restraint device 10, the latter includes a protuberant rod 12 with a free end 14 which has a disk or a hook shape, configured to hold said door in the closed position thereof.

In the embodiment illustrated in FIG. 3, the protuberant rod 12B supported by the body 6, more particularly by the middle pillar 6B of the vehicle, is outside the housing 16 located in the rear part of the door. The protuberant rod 12B is then arranged close to the front end of the rectilinear opening 40 of the door 4, which is adjacent to the locking system 50. The latter could, according to one embodiment, comprise a bolt which would be able to engage with the protuberant rod 12B, the latter then acting as a striker of the middle pillar. In such case, the restraint device 10 is partly merged with a locking system 50 for locking the sliding door 4 in the open configuration.

Thereby, the restraint device 10 serves, on the one hand, to hold the sliding door 4 in the closed position thereof, and, on the other hand, to participate in the locking system 50 in holding the sliding door 4 in the open position thereof.

FIG. 4 is an enlargement of the arrangement of FIG. 1 according to section A-A, the sliding door 4 being shown in the closed position thereof. In the closed position, the sliding door 4 closes the access to the inside of the vehicle so that the restraint device 10 extends via the protuberant rod 12 through the rectilinear opening 40, and via the end 14 thereof inside the housing 16. According to the embodiment illustrated in FIG. 4, the opening 46 formed in the partition wall 42 has a substantially rectangular cross-section, whereas the end 14 has a circular profile. The partition wall 42 connects the bottom of the casing 43 to the outer panel (not shown), at least in a zone of the door 4 situated opposite the restraint device 10.

The rectilinear opening 40 is concealed by a means of masking 60 assembled against the outer face of the bottom of the casing 43. Said means of masking 60 is deformable, same can be made from a plastic material, such as rubber. Said means of masking 60 may comprise two lips vertically opposite one another. According to a variant of embodiment (not shown), said masking means could be of the type of a comb the teeth of which extend vertically. The means of masking 60 is preferably open at the protuberant rod 12 and closed at a distance from the rod, as shown in dotted lines. Advantageously, such a means of masking 60 contributes to the sealing of the door 4, so that same could also be described as a means of sealing.

According to one example, the restraint device 10 comprises a metallic material. The metallic material may e.g. comprise aluminum. The restraint device 10 can in particular be manufactured using a molding method.

It is thereby possible to design, in the case of an arrangement 2 of a body of motor vehicle comprising a partition sliding door 4, a restraint device 10 which is apt to move inside a rectilinear opening 40 during the displacement of the door. Such a design serves to limit the thickness of the door 4 which moves outside the vehicle, which contributes to increasing the effective volume in the passenger compartment or the loading zone 8 accessible to the outside via the opening of a body 6 that the door 4 is intended to close.

Furthermore, the restraint device 10 the primary function of which is to hold the door 4 on the body 6 in the event of a lateral impact likely to cause a relative displacement between the closed sliding door 4 and the body 6, is also apt to participate in locking the door 4 in the open position. Furthermore, the arrangement 2 of the body is remarkable in that the restraint device 10 is installed discreetly, and the rectilinear opening 40 can advantageously be masked in a sealed manner.

1. An arrangement of a motor vehicle, including a body and a partition sliding door, the sliding door being configured to be displaced rectilinearly along a body side, between a closed position wherein the sliding door closes the access to the inside of a passenger compartment and/or of a loading zone of the vehicle, and an open position wherein the sliding door gives free access to the inside of the passenger compartment and/or to said loading zone of the vehicle, wherein the sliding door comprises a longitudinal rectilinear opening, provided in the sliding door, and wherein the arrangement comprises at least a restraint device intended to hold said sliding door in the closed position thereof, the restraint device being intended to move freely inside the longitudinal rectilinear opening during the sliding of the door.

2. The arrangement according to claim 1, wherein the sliding door is an outer partition sliding door.

3. The arrangement according to claim 1, wherein the longitudinal rectilinear opening is a kerf or a groove.

4. The arrangement according to claim 1, wherein the longitudinal rectilinear opening is located at a bottom wall of a casing of the sliding door.

5. The arrangement according to claim 1, wherein the restraint device is intended to hold said sliding door in the closed position in the event of an impact exerted laterally against the sliding door, the impact being exerted from the inside toward the outside of the vehicle.

6. The arrangement according to claim 1, wherein the restraint device is fastened to a front pillar of a side of the body, at the rear edge of a front pillar intended to be arranged opposite a front edge of the sliding door in the closed position.

7. The arrangement according to claim 1, wherein the restraint device is fastened to a middle pillar on a side of the body, at a front edge of the middle pillar extending substantially perpendicularly, transversely, to the inner wall of the sliding door.

8. The arrangement according to claim 6, wherein, an outer wall of the front door of the sliding door, in the closed position is flush with the front pillar, with an outer wall of the front pillar.

9. The arrangement according to claim 8, wherein the restraint device comprises a finger protruding from the side of the body of the vehicle, from the rear edge of the front pillar, said finger including a main rod extending longitudinally to the vehicle, a free end of which comprises a head, in the shape of a hook or a disc, the restraint device being spaced apart from the door, apart from the front edge of the sliding door, in such a way that same can move freely between the closed and open positions without coming into contact with the restraint device.

10. The arrangement according to claim 7, wherein the bottom wall of the casing of the sliding door extends opposite an outer edge of the middle pillar whatever the position of the sliding door.

11. The arrangement according to claim 10, wherein the restraint device comprises a finger protruding transversely from the side of the body of the vehicle, said finger including a main rod extending transversely and longitudinally to the vehicle, a longitudinally oriented free end of which comprises a head, in the shape of a hook or a disk.

12. The arrangement according to claim 9, wherein the restraint device is fastened to the front pillar of a side of the body, at the rear edge of the front pillar intended to be arranged opposite a front edge of the sliding door in the closed position and the said finger includes a fastening plate for fastening to the side of the body, the fastening plate being screwed onto the rear face of the front pillar or onto the front face of the middle pillar.

13. The arrangement according to claim 12, wherein the restraint device is intended to come into contact with the sliding door in order to hold same in the closed position on the side of the body in the event of a lateral impact.

14. The arrangement according to claim 13, wherein the restraint device is spaced apart from the sliding door, spaced apart from the edges of the longitudinal opening and/or from a passage provided at the transverse wall, the restraint device being intended to come into mechanical relation against the door, against the transverse wall of the casing, in the closed position during an impact, the wall being a reinforcement part directly mounted on the bottom wall of the casing.

15. The arrangement according to claim 1, comprising a deformable masking element for said longitudinal housing, wherein the element is a lip seal crossed through by the restraint device so as to separate lips of the lip seal.

16. A motor vehicle, comprising an arrangement according to claim 1.

17. The motor vehicle according to claim 16, wherein the arrangement is located on a side of the motor vehicle.
